(19) United States
(12) Patent Application Publication
(10) Pub. No.: US 2017/0272326 A1
(43) Pub. Date: Sep. 21, 2017

(54) DETERMINING SERVICE GROUP BASED NETWORK TOPOLOGIES

(71) Applicant: Futurewei Technologies, Inc., Plano, TX (US)

(72) Inventors: Ravishankar Ravindran, San Ramon, CA (US); Xili Wan, San Jose, CA (US); Xinjie Guan, San Jose, CA (US)

(21) Appl. No.: 15/075,698

(22) Filed: Mar. 21, 2016

(51) Int. Cl. H04L 12/24

(52) U.S. Cl. CPC H04L 41/12

(57) ABSTRACT

A method of configuring a wireless network having multiple nodes, the method including broadcasting, via an aggregator node, information centric (ICN) discovery messages to the nodes, each discovery message including service centric metadata indicative of one of a plurality of service groups, each service group associated with a different internet of things service, receiving responses at the aggregator node from nodes responsive to the metadata in the discovery messages, the responses each identifying one of the plurality of service groups, and determining via the aggregator node, multiple network service topologies, each topology corresponding to one of the plurality of service groups.

### FIELD OF THE INVENTION

The present disclosure is related to determining network topologies, and in particular to determining service group based network topologies and name based forwarding of packets using the service group topologies.

### BACKGROUND

Wireless mesh networks consist of multiple nodes that communicate with each other wirelessly by passing data, such as packets between each other. Data from one node may need to hop via multiple nodes in the mesh to reach an intended destination node. Routing is a term used to describe that path through the multiple nodes that the data takes.

Many wireless nodes today operate on battery power and have limited memory and processing resources. One type of such nodes is referred to as a constrained embedded system (CES). A CES node may be enabled with a new network layer such as information centric networking (ICN) as opposed to commonly used Internet protocol (IP) network layer, allowing name based routing, potential caching of data and utilizing smaller computing tasks. Even with the use of name based networking, conservation of battery power and efficient utilization of node resources remain a concern. Current routing mechanisms include Interest flooding mechanisms to discover routes, which is highly power inefficient for constrained devices.

### SUMMARY

A method of configuring a wireless network having multiple nodes, the method including broadcasting, via an aggregator node, information centric (ICN) discovery messages to the nodes, each discovery message including service centric metadata indicative of one of a plurality of service groups, each service group associated with a different internet of things service, receiving responses at the aggregator node from nodes responsive to the metadata in the discovery messages, the responses each identifying one of the plurality of service groups, and determining via the aggregator node, multiple network service topologies, each topology corresponding to one of the plurality of service groups.

A first node includes a processor, a communication module to couple to a network, and a storage device coupled to the processor to cause the processor to execute operations. The operations include broadcasting information centric network (ICN) discovery messages to multiple nodes, each discovery message including service centric metadata indicative of one of a plurality of service groups, receiving responses from the multiple nodes responsive to the metadata in the discovery messages, the responses each identifying one of the plurality of service groups, and determining multiple network service topologies, each topology corresponding to one of the plurality of service groups.

A method of name based routing in a network includes receiving at an aggregator node, an information centric network (ICN) interest message identifying requested data by name and service ID, the interest message originating from a node in a first path in a service group topology, including in the ICN interest message, via the aggregator node, an explicit routing object identifying a sequence of nodes belonging to a second path of the service group topology, checking via the aggregator node, a forwarding information base to identify a node containing the requested data, and forwarding the interest message from the aggregator node to the identified node containing the requested data using the sequence of nodes identified in the explicit routing object.

### BRIEF DESCRIPTION OF THE DRAWINGS

FIG. 1 is a block diagram illustrating a mesh network that includes multiple wireless constrained embedded system (CES) nodes implementing information centric network (ICN) protocols for communicating according to an example embodiment.

FIG. 2 is a block diagram illustrating multiple mesh nodes for illustrating formation of a service centric network directed acyclic graph (DAG) according to an example embodiment.

FIG. 3A is a pseudocode representation of a method of building the service centric DAG and learning of the corresponding topology according to an example embodiment.

FIG. 3B is a flowchart representation of a method of building the service centric DAG and learning of the corresponding topology according to an example embodiment.

FIG. 4 is a block diagram illustrating a mesh network with multiple service centric groups according to an example embodiment.

FIG. 5 is a block diagram of a mesh having a sink node designated SO, and five I-CES nodes for illustrating building of name based routes according to an example embodiment.

FIG. 6 is a block diagram of a mesh used to illustrate paths taken by an interest message according to an example embodiment.

FIG. 7 is pseudocode representation illustrating a method of forwarding interest messages according to an example embodiment.

FIG. 8 is a block diagram illustrating circuitry for nodes and methods performed by the nodes according to example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software in one embodiment. The software may consist of computer executable instructions stored on computer readable media or computer readable storage device such as one or more non-transitory memories or other type of hardware based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

A wireless mesh network having multiple constrained embedded system nodes is configured by broadcasting discovery messages to the nodes. Each discovery message includes service centric metadata indicative of one of a plurality of services. Responses from constrained embedded system nodes responsive to the metadata in the discovery messages each identify one of the plurality of services. Multiple network service topologies corresponding the plurality of services are identified, allowing efficient communication between nodes. Service centric directed acyclic graphs (DAGs) are built based on service requirements versus purely for connectivity. Name based routing is dynamic in the sense that no routing protocol is applied. Sink nodes may be unconstrained nodes which have enhanced routing and forwarding and computing capabilities to aid in route construction.

In one embodiment, the nodes may be internet of things devices distributed throughout a home and operating on battery power. The nodes may have limited processing capabilities and limited data storage capacity. Different devices may be related to different service groups, such as a security system or lighting use monitoring and control, and still others to a different service group such as heating ventilation and cooling (HVAC). The devices form nodes in a mesh network.

In classic methods of forming a mesh network, optimal routing of network traffic may be taken into account. Using such prior methods may result in some nodes handling network traffic from nodes that are in different services groups. Since the nodes may be battery powered, and have limited processing and data storage capacity, such a node may consume its battery energy quickly, resulting in inconvenience of a home owner who now has to replace the battery.

For example, a motion sensor from the security system service group might end up in a path that includes devices from other service groups that might cause lots of network traffic to flow through the motion sensor and drain its battery quickly. The motion sensor may also not be able to buffer all the data associated with the network traffic.

In various embodiments of the inventive subject matter, while discovering the nodes and forming the network, service groups are taken into account to make sure that mostly, if not only, nodes from a service group are used to create a topology (network of nodes) for that service group. That ensures that the motion sensor does not have to process network traffic from nodes in other service groups and the battery lasts longer.

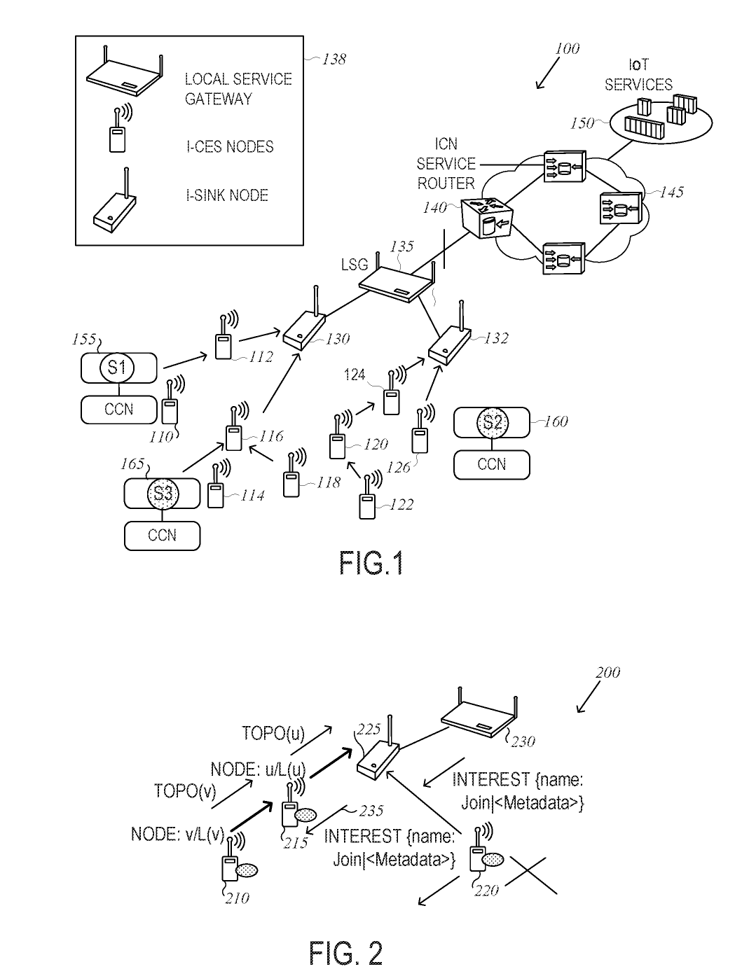

FIG. 1 is a block diagram illustrating a mesh network 100 that includes multiple wireless constrained embedded system (CES) nodes 110, 112, 114, 116, 118, 120, 122, 124, and 126 implementing information centric network (ICN) protocols for communicating. The CES nodes may be referred to as I-CES nodes, and may include leaf I-CES nodes indicated at 110, 114, 118, 122, and 126, and intermediate I-CES nodes indicated at 112, 116, 120, and 124. Two I-sink nodes 130, 132 are also shown and communicate wirelessly with multiple I-CES nodes. The I-sink nodes 130, 132 also communicate with at least one local service gateway indicated at 135. A key 138 shows symbols used to represent each of the I-CES nodes, I-sink nodes, and gateway.

In various embodiments, the I-sink nodes may be an aggregator node that collects and routes communications from the CES nodes, such as a wireless router in a home or other environment which generally runs off a larger power source, such as the grid. The I-CES nodes are generally constrained in at least one way, such as by operating off of a limited power supply such as a battery, or having limited processing and memory, or combinations thereof. The amount of constraint may be minor in some embodiments, but generally involves some modicum of constraint that makes it desirable to have the nodes separated into service groups for communication purposes.

The local service gateway (LSG) 135 may couple via an information centric router 140 to a network 145 such as the Internet, or any other type of public or private network providing services 150. In one embodiment, the services 150 are internet of things (IOT) services to receive data from I-CES nodes, which may include sensors and appliances or other network enabled devices. Examples include temperature sensors, thermostats, security sensors, alarms, entertainment devices, and thousands of other devices that may be networked in the future.

Some of the devices may be related to a particular service as indicated at S1 at 155, S2 at 160, and S3 at 165. One example service relates to heating ventilation and air conditioning (HVAC) services. Others may be related to security systems or energy consumption control services, or entertainment services, or lighting control services and others. Data from the devices may be provided to the IOT services 150 which may include applications for controlling and providing the services. The data may utilize a content centric network (CCN) protocol for message based routing. The devices associated with the different services need not all be directly connected to each other in the mesh network. For instance, a motion sensor associated with security services would rarely if ever need to directly communicate with a sensor for climate control, or a switch for a lightbulb even though the associated I-CES nodes are within communicating range of each other.

In one embodiment, each different service may have a separate service centric directed acyclic graph (DAG) constructed to identify different sets of paths in the mesh network for nodes associated with different services. The construction and use of the DAGs provides the ability to reduce traffic through nodes that are not associated with a set of nodes associated with a different service, thus preserving battery life of the nodes. Memory and computing resources may also be conserved such that they are more fully dedicated to the service they are associated with. Each service centric DAG may also be built in a cheapest way possible, while optimizing one or more of several attributes, such as height form the sink node, signal strength from its neighbors, computing and memory constraints, and battery power.

Note that in some embodiments, the services 150 may be directly coupled to and local with the local service gateway. In other words, the services 150 may comprise software applications running on local hardware in an edge cloud (the logical extremes of a network of computing resources) directly coupled (physically or wirelessly) to the mesh network.

The use of service based DAGs allows efficient communications between different devices, such as a light switch and a light bulb. For instance, node 110 may be the light switch, and node 114 may be the light bulb. Communications from the switch to the bulb may proceed from node 110 to node 112, node 130, node 116, and then to node 114. Similarly, if the light bulb is node 126, communications from the switch to the bulb may proceed from node 110, to node 112, node 130, gateway 135, node 132, to node 126. Thus, a light weight solution is provided to enable device to device interaction between multiple devices by minimizing a name forwarding state in the intermedia I-CES nodes and I-sink nodes. The nodes may receive and forward network traffic based on name based routing using a content centric network protocol or other protocols having suitable network layer functions in various embodiments.

FIG. 2 is a block diagram illustrating multiple nodes at 200 for illustrating formation of a service centric network DAG. I-CES nodes include 210, 215, and 220. An I-sink node is indicated at 225, and a gateway is indicated at 230. Node 210 is a leaf node and may be referred to as a node v/L(v), where L(v) represents the level of node v from the root of the tree. Node 215 is an intermediate node referred to as node u/L(u). Formation of a service centric network DAG begins with the sink node 225 broadcasting a discovery message, such as a CCN JOIN message indicated at 235. The JOIN message may have a JOIN interest broadcast name, and may carry metadata, such as an IOT Service-ID, representing a particular service. The JOIN message flows down to build the service centric DAG, and TOPO messages flow up to the sink to enable learning of the topology. Multiple nodes may be involved in the particular service, and respond to enforce service-centric topology creation. The metadata may also carry topology creation metric based on service requirements. Nodes that are part of the service group respond to the JOIN message via the TOPO messages as indicated at TOPO(v) at 240 and TOPO(u) at 245. Since node 220 is not a member of the service group, it does not join the tree (service centric DAG).

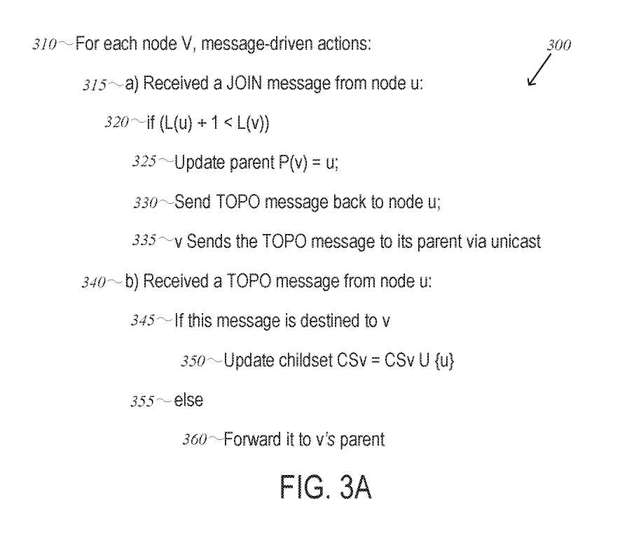

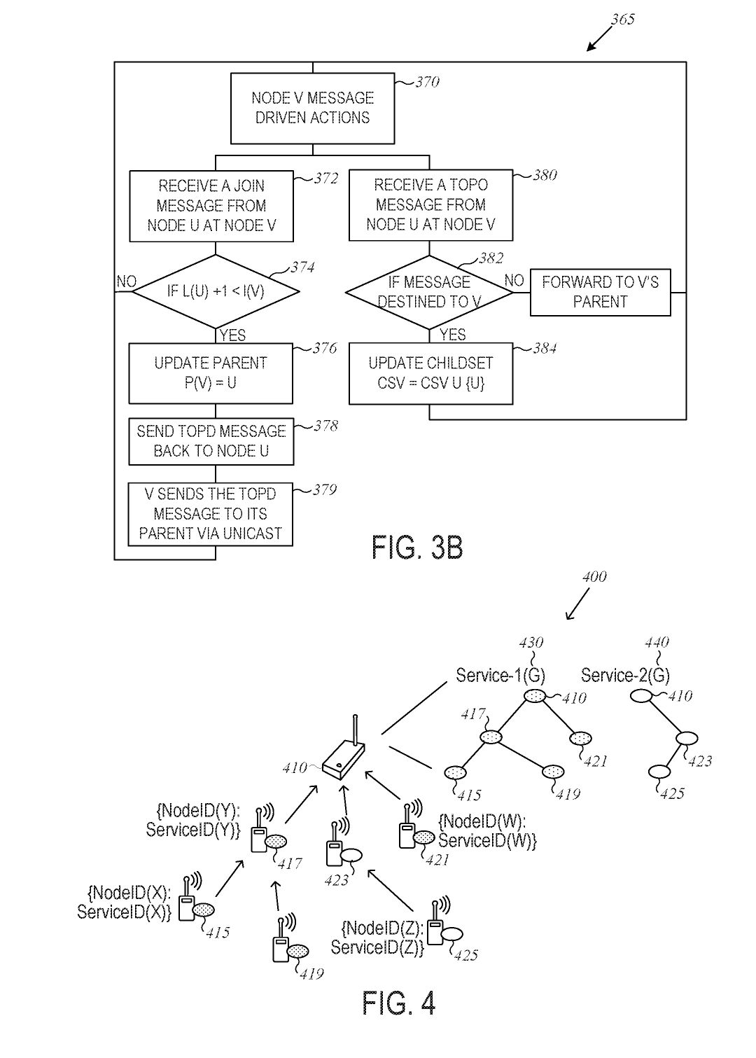

FIG. 3A is a pseudocode representation of a method 300 of building the service centric DAG and learning of the corresponding topology. For each node v, as indicated at 310, message-driven actions are performed. At 315 a JOIN message is received at node v from node u. If at 320, L(u)+1 is less than L(v), processing proceeds to 325 where parent P(v) is set equal to u. A TOPO messages is then sent at 330 back to node u, and node v sends the topo message to its parent node in a unicast manner. Thus, the join message propagates out from the sink node via the I-CES nodes.

If at 340, a TOPO message is received from node u, and if the message is destined to node v as checked at 345, the childset CSv is updated to CSvU{u} at 350, which adds node u to the childset via a union operation. Otherwise, as indicated at 355, the message is forwarded node v's parent node, identifying node u as the child of node v.

FIG. 3B is a flowchart 365 illustrating the method of building the service centric DAG and learning of the corresponding topology. For each node v, as indicated at 370, message-driven actions are performed. At 372 a JOIN message is received at node v from node u. If at 374, if L(u)+1 is less than L(v), processing proceeds to 376 where parent P(v) is set equal to u. A TOPO message is then sent at 378 back to node u, and node v sends the TOPO message to its parent node in a unicast manner at 379. Thus, the join message propagates out from the sink node via the I-CES nodes.

If at 380, a TOPO message is received from node u, and if the message is destined to node v as checked at 382, the childset CSv (comma separated values) is updated to CSvU{u} at 384, which adds node u to the childset via a union operation. Otherwise, as indicated at 386, the message is forwarded node v's parent node, identifying node u as the child of node v.

FIG. 4 is a block diagram illustrating a mesh network 400 with multiple service centric groups. The mesh 400 includes a sink node 410 and six I-CES nodes indicated at 415, 417, 419, 421, 423, and 425. The I-sink node is a member of two service groups, service-1(G) and service-2(G) as indicated at 430 and 440. Each group has different sets of I-CES nodes. Group 430 includes I-CES nodes 415, 417, 419, and 421, while group 440 includes I-CES nodes 423 and 425. The groups are set up by the sink node 410 receiving TOPO messages with parent-child relationship and the Service-ID:Node-ID mapping included. A parent-child relationship is added into the linked list data structure to build the global service-centric topology information. This is followed by setting up serviceId-nodeId mapping.

Note that the topology may be built just as non-service centric topologies are built, except that the list of nodes used to build a service centric topology belong to a single service group. In some embodiments, if a node that is not part of a service group is only within range of a node or nodes in that service group, it may also be included in the service centric topology. In some embodiments, such a node may be manually added.

Once the DAG construction achieves convergence, a name based forwarding state is used to forward communications. In further embodiments, routing tables in each node may be used to forward communications using other data forwarding protocols. Upon convergence, every leaf I-CES node has exactly one default entry to its parent. Each Intermediate I-CES node has one default towards the sink, and entries for each of its child I-CES nodes, corresponding to their Node-ID. I-CES nodes which participate in multiple service DAGs may use the Service Context-ID to logically separate the forwarding entries for the sink nodes and the child nodes in the context of the given service.

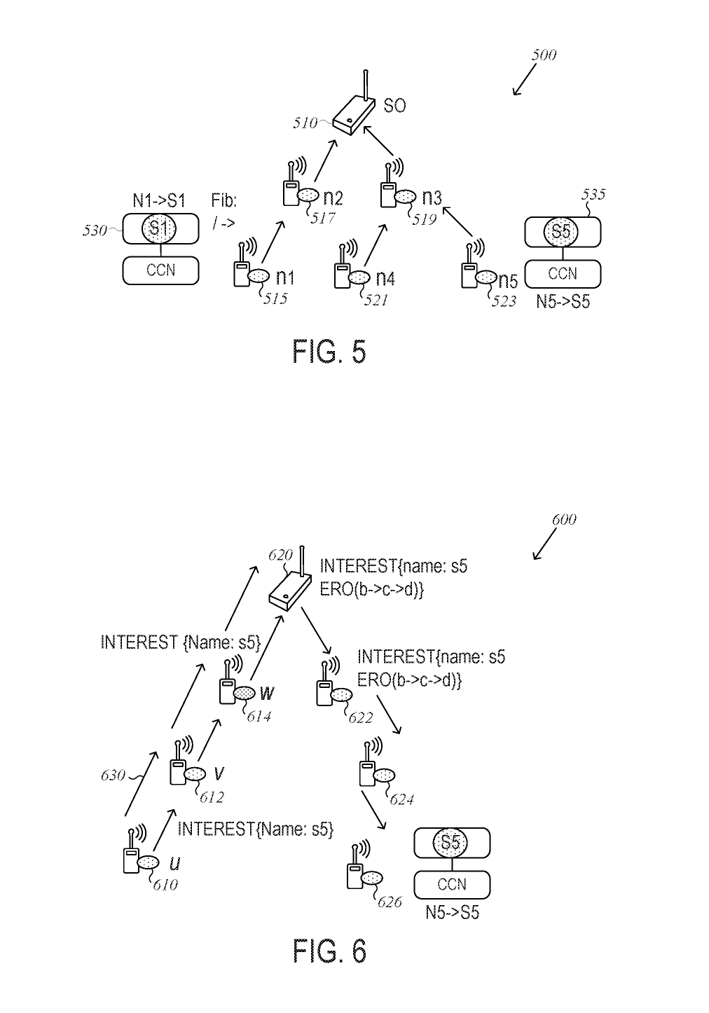

FIG. 5 is a block diagram of a mesh 500 having an I-sink node 510 designated SO, and five I-CES nodes indicated as n1 515, n2 517, n3 519, n4 521, and n5 523. Using a named based forwarding protocol, a forwarding information base (FIB) is built to forward messages in the different service groups as indicated at S1 530 and S5 535 for example. In one embodiment, name based routes are built on demand while keeping minimum state in the I-CES and I-Sink nodes.

FIG. 6 is a block diagram of a mesh 600 used to illustrate paths taken by an interest message. Mesh 600 includes I-CES nodes 610, 612, and 614 in a first path to a sink node 620, and a second path consisting of nodes 622, 624 and 626. Node 626 is a member of a service group 5. In one example, I-CES node 610 generates an interest message that identifies a name and a service group—Interest{Name:s5} as indicated at 630. In this example, the service group is designated as s5. No new CCN primitive is introduced, but the Interest definition is augmented by sink node 620 adding an Explicit Route Object ( ) in a Header of the Interest. In one embodiment, the ERO is simply a set of node ids corresponding to the path to be taken by communications related to the named content.

The forwarding logic is modified from regular CCN, considering the message has to be handled differently in the upstream and downstream propagation of messages and the restricted state in the FIB. Changes are made in the CCN forwarder of the I-CES nodes.

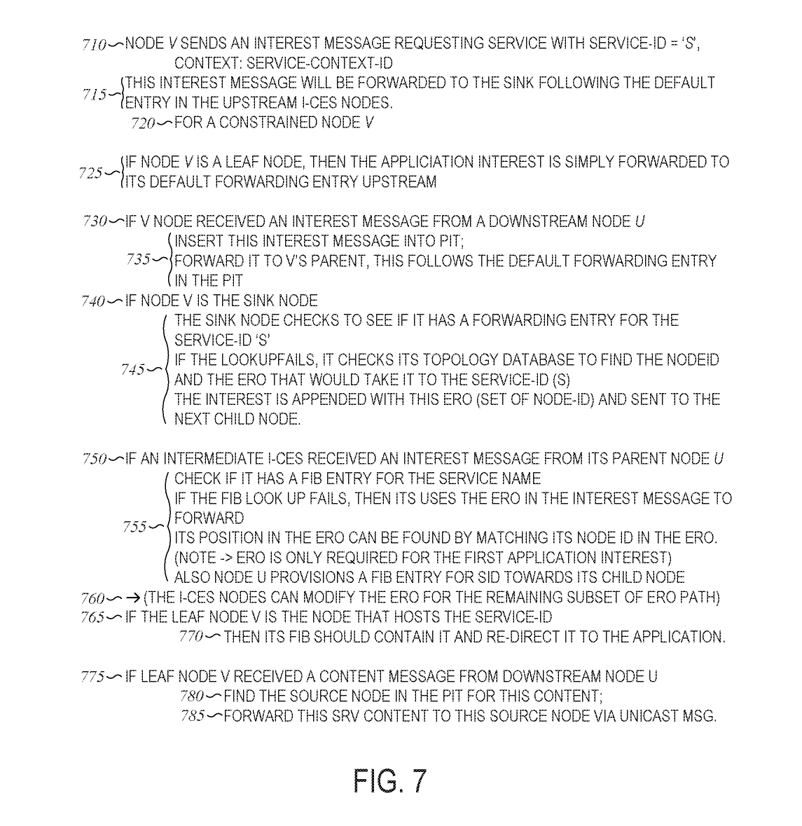

FIG. 7 is a pseudocode representation of a method 700 of forwarding interest messages. The forwarding may depend on the role of the node that is forwarding the interest message as well as the role of the node that receives the interest message. Hence, FIG. 7 is divided into multiple different segments of pseudocode to describe what happens when a communication is received or forwarded by a node based on the context of the node.

At 710, node v 612 sends an Interest message requesting service with Service-ID=‘s’, Context: Service-Context-ID. This Interest message will be forwarded to the sink at 715 following the default entry in the upstream I-CES nodes. The Interest message Context-ID may be used to ensure only the nodes within the service context will process it, allowing nodes which participate in multiple service contexts to apply appropriate FIB forwarding rules.

For a constrained node v as indicated at 720, if node v is a leaf node indicated at 725, then the application Interest is simply forwarded to its default forwarding entry upstream.

If v received an Interest message from a downstream node u as indicated at 730, the interest message is inserted at 735 into a pending interest table (PIT), and is forwarded to v's parent. The PIT records where incoming interest requests originated, and have not been replied to by the producer. This follows the default forwarding entry in the PIT.

If node v is the Sink Node as indicated at 740, at 745, the Sink node checks to see if it has a forwarding Entry for the Service-ID ‘s’ in a forwarding information base (FIB). The FIB associates content names to the forwarding face(s) towards the producer(s). If the lookup fails, it checks its topology database to find the NodeID and the ERO that would take it to the Service-ID (s). The Interest is Appended with this ERO (set of Node-ID) and sent to the next child node and may be used to explicitly construct the path in the FIB. Note that in some embodiments, appending the ERO is only done for the first Interest, reducing overhead for subsequent messages. The ERO node-ids can be any names, integers, or strings to minimize overhead, may be compared to others where fixed name definitions are utilized.

If at 750, an intermediate I-CES received an Interest message from its parent node u 610, at 755, a check is performed to determine if it has an FIB entry for the service name If the FIB look up fails, then its uses the ERO in the interest message to forward the interest message. Its position in the ERO can be found by matching its Node Id in the ERO. (Note→ERO may be used just for the first Application Interest without using it for subsequent application interests.) Also, node u 610 provisions a FIB entry for SID towards its Child Node. At 760 the I-CES nodes can modify the ERO for the remaining subset of ERO path to prune the ERO list to reduce the forwarding packet overhead.

At 765, a check is made to determine if the leaf node v is the node that hosts the Service-ID. If so, at 770 its FIB should contain it and re-direct it to the application. At 775, it is determined if it received a content message from downstream node u 610. If so, the source node is found in the PIT at 780 for this content and the service (SRV) content is forwarded to this source node via a unicast message as indicated at 785.

FIB management and the FIB data structure may provide one or more benefits. The management mechanism also holds good for Interests coming upstream from the Sink node, i.e. the LSG or other Sink nodes. The FIB entries for Service-IDs other than the child and sink NodeIDs are soft state, so can be timed out to manage the FIB entries created dynamically if there is no traffic corresponding to it. The maximum size of the FIB can also be defined, so for Interests which require FIB entry creation, it can be dropped, and a Notification can be send upstream if required. In some embodiments, the FIB entries with least activity can be removed to create space for this new entry.

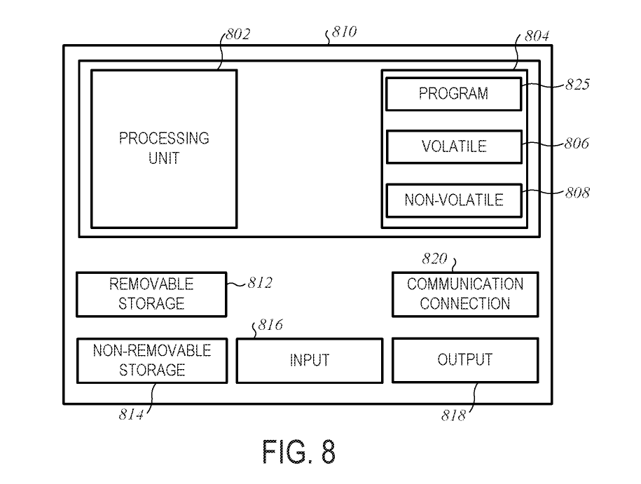

FIG. 8 is a block schematic diagram of a computer system 810 to implement methods according to example embodiments. All components need not be used in various embodiments. For example, the various nodes may each use a different set of components, or in the case of servers for example, larger storage devices. Routers, for example, may have many more communication connections to communicate in parallel with multiple servers and clients.

One example computing device in the form of a computer 810 may include a processing unit 802, memory 804, removable storage 812, and non-removable storage 814. Although the example computing device is illustrated and described as computer 810, the computing device may be in different forms in different embodiments. For example, the computing device may instead be a smartphone, a tablet, smartwatch, or other computing device including the same or similar elements as illustrated and described with regard to FIG. 8. Devices, such as smartphones, tablets, and smartwatches, are generally collectively referred to as mobile devices or user equipment. Further, although the various data storage elements are illustrated as part of the computer 810, the storage may also or alternatively include cloud-based storage accessible via a network, such as the Internet or server based storage.

Memory 804 may include volatile memory 806 and non-volatile memory 808. Computer 810 may include—or have access to a computing environment that includes—a variety of computer-readable media, such as volatile memory 806 and non-volatile memory 808, removable storage 812 and non-removable storage 814. Computer storage includes random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 810 may include or have access to a computing environment that includes input 816, output 818, and a communication connection 820. Output 818 may include a display device, such as a touchscreen, that also may serve as an input device. The input 816 may include one or more of a touchscreen, touchpad, mouse, keyboard, camera, one or more device-specific buttons, one or more sensors integrated within or coupled via wired or wireless data connections to the computer 810, and other input devices. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN), cellular, WiFi, Bluetooth, or other networks.

Computer-readable instructions stored on a computer-readable medium are executable by the processing unit 802 of the computer 810. A hard drive, CD-ROM, and RAM are some examples of articles including a non-transitory computer-readable medium such as a storage device. The terms computer-readable medium and storage device do not include carrier waves to the extent carrier waves are deemed too transitory. For example, a computer program 825 capable of providing a generic technique to perform access control check for data access and/or for doing an operation on one of the servers in a component object model (COM) based system may be included on a CD-ROM and loaded from the CD-ROM to a hard drive. The computer-readable instructions allow computer 810 to provide generic access controls in a COM based computer network system having multiple users and servers. Storage can also include networked storage such as a storage area network (SAN) via communication connection 820.

In various embodiments described above, service-centric DAG creation comprises constrained I-CES nodes, where DAGs are created with discovery messages with Service-centric metadata. A Service-centric topology learning is performed by a Sink node, so that the sink node can manage multiple topologies belonging to different IoT services. The routing/forwarding provided by use of the service-centric DAGs allows creation of multiple service IoT partitions. A distributed Dynamic name based routing mechanism uses Application Interest messages.

Inclusion of an ERO in the Interest message is used to explicitly construct the path in the FIB. The ERO node-ids can be any names, integers, strings to minimize overhead, compared to other methods of message forwarding where fixed name definitions are required.

A new forwarding mechanism for the I-CES and the I-Sink nodes is used to create and compute the ERO and append it to the Interest to create the path. Appending the ERO to the Interest is only utilized for the first Interest, other flows to the same service can leverage this one time effort without the overhead of including the ERO in subsequent flows. Dynamic creation of the name based entries may be performed when Interest with an ERO arrives.

Name based Service entries may be provided as soft state entries, so that an entry can be timed out if there is no traffic corresponding to the entry.

### EXAMPLES

1. An example method of configuring a wireless mesh network having nodes, the method including broadcasting, via an aggregator node, information centric network (ICN) discovery messages to the nodes, each discovery message including service centric metadata indicative of one of a plurality of service groups, each service group associated with a different internet of things service, receiving responses at the aggregator node from nodes responsive to the metadata in the discovery messages, the responses each identifying one of the plurality of service groups, and determining, via the aggregator node, multiple network service topologies, each topology corresponding to one of the plurality of service groups.

2. The method of example 1 wherein the topologies are represented as directed acyclic graph data structures.

3. The method of any of examples 1-2 wherein the nodes are constrained embedded system nodes that include a leaf node and a parent node, and wherein a service topology includes exactly one default entry for the leaf node to the parent node.

4. The method of example 3 wherein the constrained embedded system nodes include an intermediate node, and wherein the intermediate node includes one default entry towards a sink node, and entries for each intermediate node child node.

5. The method of any of examples 1-4 wherein the received responses contain node constraint data structures, and wherein determining multiple network service topologies determines the topologies as a function of the constraint data structures.

6. The method of example 5 wherein the node constraint data structures include computing and memory resource constraints.

7. The method of any of examples 5-6 wherein the node constraint data structures include battery power constraints.

8. The method of any of examples 5-7 wherein the node constraint data structures include neighbor signal strength constraints.

9. The method of any of examples 1-8 wherein the wherein the plurality of service groups comprise multiple service internet of things partitions and wherein the discovery messages comprising content centric network (CCN) JOIN message.

10. The method of example 9 and further comprising using nodes in the network service topologies to forward CCN interest messages.

11. The method of example 10 and further comprising:
receiving a CCN interest message;
checking a forwarding information base for a forwarding entry for a service topology;
if the forwarding information base does not have a forwarding entry, appending an explicit routing object (ERO) identifying a node path to the interest message; and
forwarding the interest message based on the ERO.

12. An example first node including a processor, a communication module to couple to a mesh network, and a storage device coupled to the processor to cause the processor to execute operations. The operations include broadcasting information centric network (ICN) discovery messages to multiple nodes, each discovery message including service centric metadata indicative of one of a plurality of service groups, each service group associated with a different internet of things service, receiving responses from the multiple nodes responsive to the metadata in the discovery messages, the responses each identifying one of the plurality of service groups, and determining multiple network service topologies, each topology corresponding to one of the plurality of service groups.

13. The first node of example 12 wherein the topologies are represented as directed acyclic graph data structures.

14. The first node of any of examples 12-13 wherein the multiple nodes include a leaf node and a parent node, and wherein a service topology includes exactly one default entry for the leaf node to the parent node.

15. The first node of example 14 wherein the multiple nodes include an intermediate node, and wherein the intermediate node includes one default entry towards a sink node, and entries for each intermediate node child node.

16. The first node of any of examples 12-15 wherein the received responses contain constrained embedded system node constraint data structures, and wherein determining multiple network service topologies determines the topologies as a function of the constraint data structures.

17. An example method of name based routing in a mesh network, the method including receiving at an aggregator node, an information centric network (ICN) interest message identifying requested data by name and service ID, the interest message originating from a node in a first path in a service group topology, including in the ICN interest message, via the aggregator node, an explicit routing object identifying a sequence of nodes belonging to a second path of the service group topology, checking, via the aggregator node, a forwarding information base to identify a node containing the requested data, and forwarding the interest message from the aggregator node to the identified node containing the requested data using the sequence of nodes identified in the explicit routing object.

18. The method of example 17 wherein if the interest message is received from a downstream node, the message is forwarded to a parent node.

19. The method of any of examples 17-18 wherein if the interest message is received from a parent node, a forwarding information base is first checked for a matching entry and if not successful, the explicit route object is used to forward the interest message.

20. The method of example 19 wherein the explicit routing object is added in a header of the ICN interest message, and further including explicitly constructing a path in the forwarding information base to reduce overhead for subsequent messages.

21. An example first node includes a processor, a communication module to couple to a mesh network, and a storage device coupled to the processor to cause the processor to execute operations. The operations include receiving a JOIN message from a second node, the join message including a service group identifier, if the service group identifier corresponds to a service group of the first node, identifying the second node as a parent node of first node, receiving a TOPO message from the second node, and learning a topology of the mesh network responsive to the TOPO message.

22. The first node of example 21 wherein the topologies are represented as directed acyclic graph data structures, wherein the nodes include a leaf node and a parent node, and wherein a service topology includes exactly one default entry for the leaf node to the parent node.

23. The first node of example 22 wherein the constrained embedded system nodes include an intermediate node, and wherein the intermediate node includes one default entry towards a sink node, and entries for each intermediate node child node.

24. An example node includes a processor, a communication module to couple to a mesh network and a storage device coupled to the processor to cause the processor to execute operations. The operations include receiving a discovery message, the discovery message including a service group identifier and if the service group identifier corresponds to a service group of the node, responding with a message identifying the node indicating that the node is a member of the service group.

25. The node of example 24 wherein the discovery message comprises a content centric information network JOIN message and wherein the response comprises a TOPO message.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

What is claimed is:

1. A method of configuring a wireless network having multiple nodes, the method comprising:
broadcasting, via an aggregator node, information centric network (ICN) discovery messages to the nodes, each discovery message including service centric metadata indicative of one of a plurality of service groups, each service group associated with a different internet of things service;
receiving responses at the aggregator node from nodes responsive to the metadata in the discovery messages, the responses each identifying one of the plurality of service groups; and
determining, via the aggregator node, multiple network service topologies, each topology corresponding to one of the plurality of service groups.

2. The method of claim 1 wherein the topologies are represented as directed acyclic graph data structures.

3. The method of claim 1 wherein the nodes are constrained embedded system nodes that include a leaf node and a parent node, and wherein a service topology includes exactly one default entry for the leaf node to the parent node.

4. The method of claim 3 wherein the constrained embedded system nodes include an intermediate node, and wherein the intermediate node includes one default entry towards a sink node, and entries for each intermediate node child node.

5. The method of claim 1 wherein the received responses contain node constraint data structures, and wherein determining multiple network service topologies determines the topologies as a function of the constraint data structures.

6. The method of claim 5 wherein the node constraint data structures include computing and memory resource constraints.

7. The method of claim 5 wherein the node constraint data structures include battery power constraints.

8. The method of claim 5 wherein the node constraint data structures include neighbor signal strength constraints.

9. The method of claim 1 wherein the wherein the plurality of service groups comprise multiple service internet of things partitions and wherein the discovery messages comprising content centric network (CCN) JOIN message.

10. The method of claim 9 and further comprising using nodes in the network service topologies to forward CCN interest messages.

11. The method of claim 10 and further comprising:
receiving a CCN interest message;
checking a forwarding information base for a forwarding entry for a service topology;
if the forwarding information base does not have a forwarding entry, appending an explicit routing object (ERO) identifying a node path to the interest message; and
forwarding the interest message based on the ERO.

12. A first node comprising:
a processor;
a communication module to couple to a network; and
a storage device coupled to the processor to cause the processor to execute operations, the operations comprising:
broadcasting information centric network (ICN) discovery messages to multiple nodes, each discovery message including service centric metadata indicative of one of a plurality of service groups, each service group associated with a different internet of things service;
receiving responses from the multiple nodes responsive to the metadata in the discovery messages, the responses each identifying one of the plurality of service groups; and
determining multiple network service topologies, each topology corresponding to one of the plurality of service groups.

13. The first node of claim 12 wherein the topologies are represented as directed acyclic graph data structures.

14. The first node of claim 12 wherein the multiple nodes include a leaf node and a parent node, and wherein a service topology includes exactly one default entry for the leaf node to the parent node.

15. The first node of claim 14 wherein the multiple nodes include an intermediate node, and wherein the intermediate node includes one default entry towards a sink node, and entries for each intermediate node child node.

16. The first node of claim 12 wherein the received responses contain constrained embedded system node constraint data structures, and wherein determining multiple network service topologies determines the topologies as a function of the constraint data structures.

17. A method of name based routing in a network, the method comprising:
receiving at an aggregator node, an information centric network (ICN) interest message identifying requested data by name and service ID, the interest message originating from a node in a first path in a service group topology;
including in the ICN interest message, via the aggregator node, an explicit routing object identifying a sequence of nodes belonging to a second path of the service group topology;
checking, via the aggregator node, a forwarding information base to identify a node containing the requested data; and
forwarding the interest message from the aggregator node to the identified node containing the requested data using the sequence of nodes identified in the explicit routing object.

18. The method of claim 17 wherein if the interest message is received from a downstream node, the message is forwarded to a parent node.

19. The method of claim 17 wherein if the interest message is received from a parent node, a forwarding information base is first checked for a matching entry and if not successful, the explicit route object is used to forward the interest message.

20. The method of claim 19 wherein the explicit routing object is added in a header of the ICN interest message, and further comprising explicitly constructing a path in the forwarding information base to reduce overhead for subsequent messages.
